(19) United States
(12) Patent Application Publication
(10) Pub. No.: US 2017/0024301 A1
(43) Pub. Date: Jan. 26, 2017

(54) CROSS-COMPONENT STATUS INDICATORS

(71) Applicant: NetApp, Inc., Sunnyvale, CA (US)

(72) Inventor: Allen E. Tracht, Pittsburgh, PA (US)

(21) Appl. No.: 14/806,846

(22) Filed: Jul. 23, 2015

(51) Int. Cl. G06F 11/32; G06F 11/30; G06F 15/173; G06F 13/28; G06F 13/42

(52) U.S. Cl. CPC G06F 11/327; G06F 13/28; G06F 13/4282; G06F 15/17331; G06F 11/3027; G06F 11/3048; G06F 11/3037

(57) ABSTRACT

It is determined to write a status indicator to a second component. In response to determining to write the status indicator to the second component, a first command is sent to the second component. The first command comprises the status indicator and an indication of a first memory location. The first component receives the status indicator from the second component. In response to receiving the status indicator from the second component, the status indicator is written to the second memory location in memory associated with the first component.

### BACKGROUND

Aspects of the disclosures herein generally relate to the field of computing system communications, and, more particularly, to movement of data over high availability data communication buses.

Some communication protocols explicitly provide for confirmation that data has been received by a target component. For example, each time a target component receives data, the target component sends an indication to an initiating component that the data was received. Some communication protocols, on the other hand, do not provide for explicit confirmations that data has been received. Instead, confirmation is provided for implicitly by allowing the initiating component to read data from the target component.

### OVERVIEW

Some communication protocols do not provide for explicit acknowledgements when data is received and/or write commands have been processed and the associated data written to target components. To verify that a write command has been processed and the associated data written, a status indicator can be written to a target component. The status indicator can then be read back from the target component. If the target component processes read commands after write commands, receiving the status indicator from the target component in response to a read command indicates that prior write commands have been processed. In some instances, echo commands can be employed. Instead of writing a status indicator to the target component and issuing a subsequent read command, an echo command can be issued. The echo command includes the status indicator and generally results in the status indicator being written to the target component. However, instead of waiting for a subsequent read command, the target component sends a response to the echo command after previous write commands have completed.

### BRIEF DESCRIPTION OF THE DRAWINGS

The disclosures herein may be better understood by referencing the accompanying drawings.

FIG. 1 depicts a direct memory access system including a DMA module with cross-component status indicators.

FIG. 2 depicts a flowchart of example operations for determining the current DMA write status indicator.

FIG. 3 depicts a flowchart of example operations for writing data and an associated status indicator to the memory of a target component.

FIG. 4 depicts a flowchart of example operations for reading a status indicator from a target component.

FIG. 5 depicts a flowchart of example operations for receiving a status indicator write command and a status indicator read command at a target component.

FIG. 6 depicts a direct memory access system including a DMA module with echo command functionality.

FIG. 7 depicts a flowchart of example operations for determining the current status indicator using an echo command.

FIG. 8 depicts a flowchart of example operations for writing a data block and implementing an echo command.

FIG. 9 depicts a flowchart of example operations for receiving an echo command at a target component.

FIG. 10 depicts a direct memory access system including a DMA module with echo command functionality.

FIG. 11 depicts a flowchart of example operations for receiving a request to register an echo command identifier by an initiator DMA module.

FIG. 12 depicts a flowchart of example operations for receiving a request to register an echo command identifier by a target DMA module.

FIG. 13 depicts a direct memory access system including a DMA module with echo command functionality.

FIG. 14 depicts a flowchart of example operations for processing an echo command by a target DMA module using a registered destination memory address.

FIG. 15 depicts a flowchart of example operations for using cross-component status indicators.

FIG. 16 depicts an example computing system with a DMA module that includes cross component status indicators and/or echo command functionality.

### DESCRIPTION OF EXAMPLE ILLUSTRATION(S)

The description that follows includes example systems, methods, techniques, instruction sequences and computer program products that embody techniques of the disclosures herein. However, it is understood that the described features may be practiced without these specific details. For instance, although examples refer to direct memory access protocols, the disclosures can also apply to other communication protocols. In other instances, well-known instruction instances, protocols, structures and techniques have not been shown in detail in order not to obfuscate the description.

When designing reliable communication protocols, the nature of the transmission medium is generally taken into account. For example, some transmission media may be impacted by environmental noise and/or other factors, potentially resulting in data loss when the data is transmitted over the transmission medium. Some transmission media, on the other hand, might be designed to have a low incidence of data loss. For example, memory buses within a computing system may be implemented using techniques to mitigate data loss. Even transmission media that are sometimes subject to data loss might have a low incidence of data loss over particular spans (e.g., short spans or within controlled environments). Thus, in some instances, a particular transmission medium might be considered “lossy”, while in other instances the same transmission medium might not be considered lossy.

A reliable communication protocol designed for a lossy transmission medium might specify that, after a target component receives each grouping of data (hereinafter “block of data”), the target component sends an indication that the block of data was received (e.g., an acknowledgement message, or “ACK”). Thus, the initiator can track replies from the target component to determine which blocks of data were received and processed.

When protocols are designed for a lossless (or otherwise generally reliable transmission medium), the protocols are generally implemented under the assumption that blocks of data sent over the transmission medium will reach the destination. Thus, the protocols might not provide for explicit replies from the target component. In some instances, however, it is still useful to determine which write commands have been successfully processed. To determine which write commands have been successfully processed, the initiator can write and read a token to the target component with an attribute that these commands are to be processed strictly in order. In other words, the initiator issues a write command indicating that a particular token should be written to a particular location in memory. After issuing the write command, the initiator issues a read command that indicates the same location in memory. Because the commands (or a subset thereof) are processed in order, receiving the token in response to the read command indicates that all preceding commands have been processed.

An example of a class of protocols designed for reliable transmission media is direct memory access (“DMA”) protocols, such as the Peripheral Component Interface (“PCI”) Express and the Remote Direct Memory Access protocols. DMA protocols allow an initiator to write data directly to a target component's memory (or portions thereof). DMA protocols generally assume that the transmission medium between the components is reliable or are built on other reliable communication protocols. For example, PCI Express is typically used to communicate over system buses within a computing system and includes sufficient error correction built into the protocol. RDMA protocols, on the other hand, can be implemented on top of the Transmission Control Protocol (“TCP”) or InfiniBand (“IB”), which already include mechanisms to ensure reliable delivery of data over unreliable transmission media.

Components that implement a DMA protocol generally include memory, a DMA module, and an agent. “Initiating components” (hereinafter “initiators”) issue DMA commands to “target components” (hereinafter “targets”). The agent, which can be a software agent, hardware agent, etc., issues one or more write command(s) to the DMA module. The DMA module subsequently issues the write command(s), along with the associated block(s) of data, to the target. Once the DMA module issues the write command(s) to the target, the DMA module writes a status indicator to the memory of the initiator. The agent reads the status indicator from the initiator's memory and determines that the DMA module has issued the write command to the target. However, because the status indicator is written after the write command is issued, not in response to a confirmation from the target, the status indicator does not indicate that the data associated with the write command has actually been written. Thus, the agent issues a second write command to the DMA module specifying a token to write to the target. After issuing the second write command, the agent issues a read command to read the token back from the target. The target responds to the read command by sending the token back to the initiator's DMA module which then writes it to the initiator's memory. Because the commands are processed by the target in order, writing the token back to the initiator's memory indicates that the previous write commands have been processed by the target (i.e., written to memory on the target). The token need not be separate from other data written to the target; instead, the initiator DMA module may treat a portion of data written to the target as the token. In other words, the initiator DMA module may read the last portion of the last data written to the target instead of writing and reading a separate token.

Because the DMA protocol does not include explicit acknowledgement messages from the target, the DMA module's status indicator is indicative of what commands have been issued by the initiator's DMA module, not which commands have been processed by the target's DMA module. In other words, just because the status indicator indicates that the seventeenth write command has been issued does not mean that data associated with the seventeenth write command has actually been written to the target's memory. Consider, for example, the fact that the target's DMA module might perform some processing on a received block of data or otherwise not write the received data to memory immediately. If the agent relies on the status indicator only, the agent may perform an action prior to the data being written to memory. Thus, this technique can result in a disconnect between what the status indicator indicates and what data has been written to the memory of the target.

To mitigate the disconnect between the information available to the agent and the completion status of write commands on a target, instead of writing the status indicator directly to the memory of the initiator, a DMA module writes the status indicator to the memory of the target. Then, instead of querying the status indicator stored in the initiator, the agent issues a read command that specifies the memory location of the status indicator in the target's memory. Once the status indicator is read from the target and written to the initiator's memory, the agent reads the status indicator from the initiator's memory. Because the status indicator is first written to the memory on the target, the initiator's copy of the status indicator indicates that data associated with each write command preceding the status indicator write command has been processed and written to the memory of the target. The agent is thus capable of determining that all write commands up through the status indicator write command have been written to the target's memory instead of merely determining that all previous write commands have been issued.

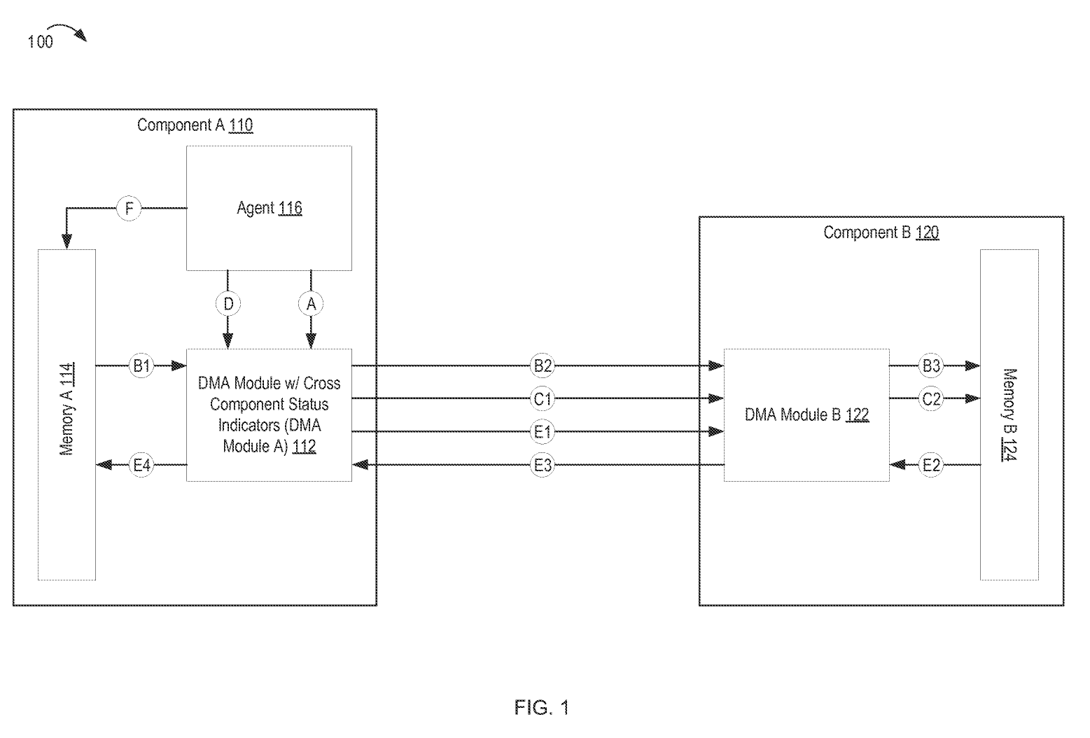

FIG. 1 depicts a direct memory access system including a DMA module with cross-component status indicators. FIG. 1 depicts a direct memory access system 100 including two components, component A 110 and component B 120. Component A 110 includes a DMA module with cross-component status indicators (hereinafter “DMA module A”) 112, memory A 114, and agent 116. Component B 120 includes DMA module B 122 and memory B 124. DMA module A 112 and DMA module B 122 each implement one or more DMA protocol(s).

In this example, component A 110 functions as the initiator and component B 120 functions as the target. However, components can generally act as targets and/or initiators. For example, DMA module B 122 can also include cross-component status indicators and can perform similar functions in parallel with DMA module A 112. Further, component A 110 and component B 120 can be components within a single computing system or can be individual computing systems themselves. For example, component A 110 might be a system bus controller on a motherboard and component B 120 might be a graphics card coupled to the motherboard via a PCI Express bus. As another example, component A 110 and component B 120 might be nodes of a distributed computing system coupled via the Internet. Component A 110 and component B 120 can be coupled with each other via any suitable transmission medium (not depicted).

At stage A, the agent 116 issues a write command to DMA module A 112. The write command identifies a source memory address and a destination memory address. The source memory address identifies a location in memory A 114 at which a block of data to be written is stored. The destination memory address identifies a location in memory B 124 to which the block of data is to be written to. For example, if the DMA protocol operates on fixed-sized blocks of data, the source and destination memory addresses might identify the beginning of the block of data. The write command might include additional metadata as well. For example, if the DMA protocol operates on variable-sized blocks of data, the write command might also indicate the size of the block of data. Other examples of metadata that might be included in the write command are a target identifier, an initiator or agent identifier, etc. The agent 116 can issue the write command by communicating directly with DMA module A 112, writing the command to a particular location in memory A 114, etc.

Stages B1 through B3 depict the operations performed to carry out the write command. At stage B1, DMA module A 112 reads the block of data indicated by the source memory address specified in the write command. DMA module A 112 can buffer the block of data in internal memory.

At stage B2, DMA module A 112 issues a write command to DMA module B 122. The write command issued to DMA module B 122 identifies a destination memory address, which is generally the same destination memory address as identified in the write command issued by the agent 116 at stage A. In some instances, however, DMA module A 112 might translate the destination memory address into a different destination memory address. The write command can also indicate the size of the block of data, initiator or agent identifier, etc. The write command also includes the block of data. In some instances, DMA module A 112 might be coupled directly to the transmission medium, allowing DMA module A 112 to send the block of data directly to DMA module B 122. In some instances, DMA module A 112 is not coupled directly to the transmission medium, thus utilizing other components, such as a network interface card (not depicted), to actually transmit the block of data over the transmission medium.

At stage B3, DMA module B 122 receives, processes, and writes the block of data received from DMA module A 112 to memory B 124. As DMA module B 122 receives the write command and block of data, DMA module B 122 can store the write command metadata and block of data in one or more buffers. The particular processing performed by DMA module B 122 can vary. For example, the block of data might include error correcting codes which the DMA module B 122 can analyze to determine whether any errors occurred in the transmission of the data and, if possible, correct the errors. DMA module B 122 might also determine whether the agent 116 has permission to write to the destination memory address or might translate the destination memory address into a different memory address. After processing the write command and the block of data (if appropriate), DMA module B 122 writes the block of data to the destination memory address (or translated memory address) in memory B 124.

Stages C1 and C2 depict the writing of the status indicator to memory B 124. Stage C1 is typically initiated soon after stage B2. Thus, stage C1 might occur in parallel with stage B3. The specific scenarios in which the status indicator is written to memory B 124 can vary. For example, a status indicator can be written after each block of data is written, after a certain number of blocks of data are written, after a certain quantity of data is written (e.g., sixteen kilobytes), in response to the agent 116 indicating that the status indicator should be written, etc.

At stage C1, DMA module A 112 issues a write command to DMA module B 122. The write command issued to DMA module B 122 identifies a destination memory address. The destination memory address is typically predetermined by DMA module A 112 (or another component) as being the location at which the status indicator is stored. Similar to other write commands, the write command can also indicate the size of the status indicator (which is, functionally, a block of data), initiator or agent identifier, etc. The write command includes the status indicator. The specific status indicator used can vary. For example, the status indicator may be an integer that is incremented each time the status indicator is written to memory B 124. As another example, the status indicator might be an identifier associated with a previous block of data. The status indicator is typically a unique value relative to other status indicators, however.

At stage C2, DMA module B 122 receives, processes, and writes the status indicator to memory B 124. As DMA module B 122 receives the write command and status indicator, DMA module B 122 can store the write command metadata and status indicator in one or more buffers. In this particular example, DMA module B 122 treats the write command received as a typical write command. In other words, DMA module B 122 does not differentiate between a write command that includes a normal block of data and a write command that include a status indicator. DMA module B 122 thus can process and write the status indicator in a manner substantially similar to that described above at stage B3.

At stage D, the agent 116 issues a read command to DMA module A 112. The read command specifies a source memory address and a destination memory address, similar to a write command. The source memory address identifies the location of the status indicator stored in memory B 124 (the memory of the target) and the destination memory address identifies the location in memory A 114 (the memory of the initiator) to which the status indicator should be written. Thus, the read command differs from a write command, in that the source memory address identified by the read command refers to a location in memory B 124, whereas the source memory address identified by the write command refers to a location in memory A 114. Similarly, the destination memory address identified by the read command refers to a location in memory A 114, whereas the destination memory address identified by the write command refers to a location in memory B 124. Finally, the read command differs in that the data being sent is accompanied by an identifier of the corresponding read command, so that the receiving DMA module (e.g., DMA module A 112) can determine the address to write the data. The data associated with a write command, on the other hand, is accompanied by the destination address information so the receiving DMA module (e.g., DMA module B 122) can write the data to the supplied address. In essence, the read command is a request for DMA module B 122 to send a particular block of data to DMA module A 112, which writes it to memory A 114. Similar to a write command, the read command can include the size of the block of data to read, a source component or agent identifier, etc.

Stages E1 through E4 depict the reading of the status indicator from memory B 124. Similar to stages A and B1, stage E1 generally occurs in response to receiving the read command issued by the agent 116 at stage D.

At stage E1, DMA module A 112 issues a read command to DMA module B 122. The read command issued to DMA module B 122 identifies a source memory address and a read command identifier. The same source memory address is generally the same as the source memory address identified in the read command issued by the agent 116 at stage D. In some instances, however, DMA module A 112 might translate the source memory address into a different source memory address. The read command identifier uniquely identifies the read command. DMA module A 112 stores the read command identifier in an entry in a buffer along with the destination memory address identified in the read command issued by the agent 116 at stage D. The read command identifier and destination memory address are stored so that DMA module A 112 can look up the destination memory address based on the read command identifier, which is returned with a read-response, as described below. The read command can also indicate the size of the block of data, source component or agent identifier, etc.

At stage E2, DMA module B 122 receives and processes the read command and reads the status indicator from memory B 124. The particular processing of the read command performed by DMA module B 122 can be similar to the processing of write commands, as described above. In response to the read command, DMA module B 122 reads the status indicator from the location in memory B 124 indicated by the source memory address. After being read from memory B 124, the status indicator can be stored in a buffer (not depicted) associated with DMA module B 122.

At stage E3, DMA module B 122 issues a read-response to DMA module A 112. The read-response issued to DMA module A 112 includes the read command identifier associated with the read command received at stage E2 and includes the data requested by the read command. The read-response can also indicate the size of the status indicator, source component or agent identifier, etc. In this instance, the read-response includes the status indicator as the requested data.

At stage E4, DMA module A 112 receives, processes, and writes the status indicator received from DMA module B 122 to memory A 114. As DMA module A 112 receives the status indicator, DMA module A 112 can store the read-response metadata and status indicator in one or more buffers. DMA module A 112 can process the read-response and status indicator similarly to processing other DMA commands, as described above. As described above at stage E1, DMA module A 112 stores the read command identifier in a buffer along with the destination memory address. Thus, to write the status indicator to memory, DMA module A 112 looks up the destination memory address in a buffer based on the read command identifier, which is included in the read response. After determining the destination memory address, DMA module A 112 writes the status indicator to the destination memory address (or translated memory address) in memory A 114.

At stage F, the agent 116 determines that the status indicator has been written to memory A 114 and reads the status indicator from memory A 114. The particular mechanism used to determine that the status indicator has been written to memory can vary. For example, DMA module A 112 might notify the agent 116 that the status indicator has been written to memory A 114 via an interrupt or similar messaging mechanism. As another example, the agent 116 might maintain a copy of the previous status indicator. After issuing the read command at stage D, the agent 116 might periodically read the status indicator from the memory A 114 and compare the current status indicator to the previous status indicator. If the current status indicator and the previous status indicator do not match, the agent 116 determines that the status indicator has been written to memory A 114. Thus, the determination that the status indicator has been written to memory A 114 and the reading of the status indicator can be combined.

Although FIG. 1 only depicts one agent, there may be multiple agents. When there are multiple agents, each agent might have an associated status indicator. The general technique(s) described above can remain the same (or possibly differ, if appropriate). Each agent can write their respective status indicator to a reserved memory location in memory A 114 (when reading the status indicator) and memory B 124 (when writing the status indicator), thus avoiding collisions.

Similarly, there can be multiple targets. In such instances, the agent 116 can specify which of the targets a write command is directed to. DMA module A 112 can then issue write commands directly to the target. In some instances, multiple targets will share a single communications bus. In such instances, DMA module A 112 might issue the write command on the bus and indicate that the write command is directed to a particular component. DMA module B 122 can be adapted accordingly as well.

Similarly, there can be multiple DMA modules. For example, a first DMA module may be configured to communicate with other components in the computing system that comprises component A 110, while a second DMA module is configured to communicate with other components external to the computing system that comprises component A 110. As another example, multiple DMA modules might be implemented to allow higher communication bandwidth by allowing more read and/or write operations to be issued in parallel.

In some instances, DMA module A 112 can support a status indicator read command. A status indicator read command might replace the read command issued by the agent 116 at stage D. In such instances, DMA module A 112 can maintain the status indicator, source and destination memory addresses, etc. Thus, at stage D, DMA module A 112 issues a status indicator read command which need not specify at least some of the metadata a conventional/standard read command might specify, such as the source memory address.

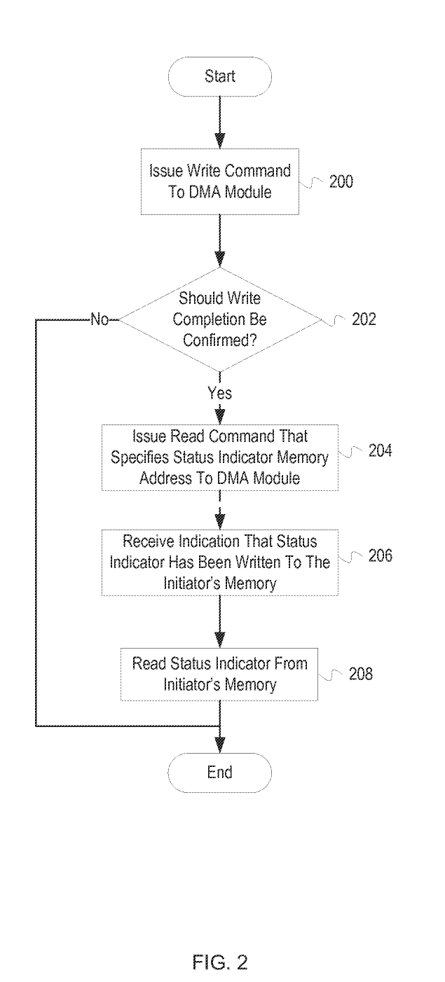

FIG. 2 depicts a flowchart of example operations for determining the current DMA write status indicator. The operations can be performed by an agent, such as the agent 116 depicted in FIG. 1, or any suitable component.

At block 200, an agent issues a write command to a DMA module. The write command, as described above, indicates a source memory address and a destination memory address. The write command can also indicate a size of a block of data identified by the source memory address, an agent identifier, etc. The write command can be issued to the DMA module using inter-process messaging, by writing to a particular location in memory, etc. After the write command is issued to the DMA module, control then flows to block 202.

At block 202, the agent determines whether completion of the write should be confirmed. For example, the agent might determine that another write command will be sent that overwrites a portion of the memory written to by the write command. Thus, if the initial write command did not complete, issuing the next write command might result in corrupt data. As another example, the agent might be configured to verify all writes of data blocks containing critical data. If the agent determines that completion of the write should be confirmed, control then flows to block 204. If the agent determines that completion of the write should not be confirmed, the process ends.

At block 204, the agent issues a read command to the DMA module. The read command specifies a source memory address and a destination memory address, as described above. The source memory address identifies the memory address at which the status indicator is stored in the memory of a target. The destination memory address identifies the memory address at which the status indicator should be stored in the memory of the initiator. Similar to a write command, the read command can include the size of the status indicator and component or agent identifiers. After the agent issues the status indicator read command to the DMA module, control then flows to block 206.

At block 206, the agent receives an indication that the status indicator has been written to the initiator memory. As indicated by the dashed line, the indication may be received asynchronously. In other words, the agent may perform other operations while waiting for the indication that the status indicator has been written to the initiator memory. The particular indication might be received via an interrupt, inter-process messaging, etc. The indication might only indicate that the status indicator has been written or can contain other information, such as the particular memory location the status indicator is stored at. After the agent receives the indication that the status indicator has been written to the initiator memory, control then flows to block 208.

At block 208, the agent reads the status indicator from the initiator memory. As described above, the particular memory location at which the status indicator is stored might be known to the agent when issuing the status indicator read command or may be received as part of the indication that the status indicator has been written to memory. After the agent reads the status indicator from the initiator memory, the process ends.

As described above in relation to FIG. 1, the agent might determine that the status indicator has been written to the initiator memory by polling a known location in the initiator memory and comparing the value to a previous status indicator value. The operations depicted in FIG. 2 can be adapted accordingly.

Generally, DMA modules include command queues, allowing the agent to issue multiple commands to a DMA module prior to previous commands completing. Thus, the agent can perform the operations depicted in FIG. 2 to enqueue status indicator read commands at various points in a stream of commands. For example, the agent might issue sets of five write commands, each set followed by a status indicator read command. By reading the status indicator from the initiating component's memory, the agent can determine which sets of enqueued commands have completed. For example, if the agent determines that the status indicator stored in the initiating component's memory corresponds to the third status indicator read request, the agent can determine that the first three sets of five write commands have completed.

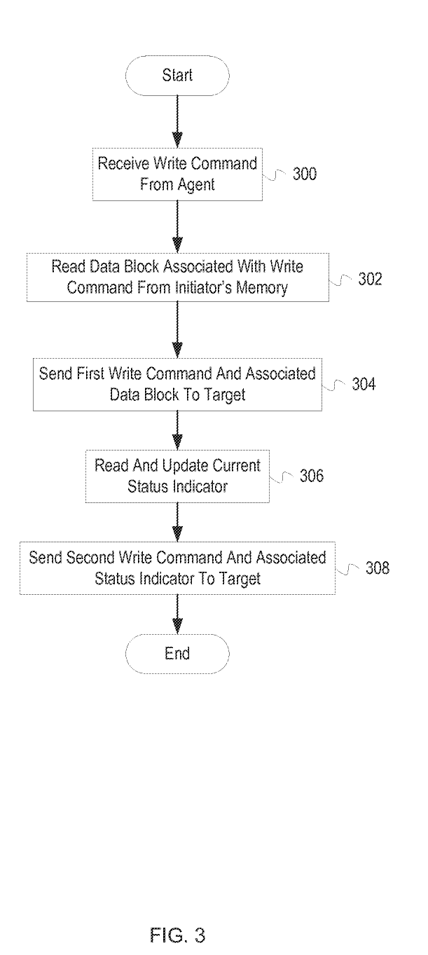

FIG. 3 depicts a flowchart of example operations for writing data and an associated status indicator to the memory of a target. The operations depicted in FIG. 3 can be performed by a DMA module, such as DMA module A 112 of FIG. 1, or any suitable component.

At block 300, a DMA module receives a write command from an agent. The write command specifies a source memory address and a destination memory address, as described above. The source memory address identifies the location of the block of data to be written. The destination memory address identifies the location to which the block of data is to be written. The write command can also specify the size of the block of data, an identifier of the initiator or the agent, etc. The write command may be read from a queue associated with the DMA module or the agent. After the DMA module receives the write command from the agent, control then flows to block 302.

At block 302, the DMA module reads the block of data associated with the write command from the initiator's memory. Typically, to read the block of data, the DMA module sends the source memory address of the block of data (and size, if appropriate) to a memory controller or other memory component. The memory component, in turn, sends the data located at the source memory address to the DMA module. After the DMA module reads the data block associated with the write command from the initiator memory, control then flows to block 304.

At block 304, the DMA module sends a first write command and the associated block of data to the target. The first write command specifies the destination address memory address at which the block of data is to be stored. The first write command can also indicate the size of the block of data, if appropriate. The DMA module might utilize additional components, such as a network interface card, to send the first write command and the associated block of data to the target. After the DMA module sends the first write command and the associated block of data to the target, control then flows to block 306.

At block 306, the DMA module updates the current status indicator. The current status indicator can be stored in a register associated with the DMA module, a buffer, etc. The current status indicator may be read from the register and updated or generated based on related metadata. The current status indicator is updated to a different unique value. For example, if the status indicator is an integer, the stored status indicator might be incremented by one. As another example, if the status indicator is based on other metadata, the status indicator may be updated to reference the write command sent at block 304. After the DMA module reads and updates the current status indicator, control then flows to block 308.

At block 308, the DMA module sends a second write command and an associated status indicator to the target. The second write command can be substantially similar to the first write command. For example, the second write command specifies a destination memory address to which the status indicator is to be written. The second write command can also include the size of the status indicator, component or agent identifiers, etc. After the DMA module sends the second write command and the associated status indicator to the target, the process ends.

As described above in relation to FIG. 1, a status indicator might be written to a target in response to a command or indication from the agent, after a certain number of blocks of data have been written to a target, after a certain amount of data has been written to the target, etc. Thus, the DMA module might perform associated operations in addition to the operations depicted in FIG. 3. For example, the write command received from the agent (block 300) might include a flag indicating that the write command should be verified. The DMA module can perform operations to detect the flag and only issue the second write (block 308) if the flag is detected. As another example, after sending the first write command (block 304), the DMA module might increment a counter that specifies the number of write commands that have been issued. The DMA module might then compare the counter to a (potentially configurable) threshold value. If the counter is greater than the threshold value, the DMA module proceeds to block 308 and, in addition to sending the second write command, resets the counter. If the counter is not greater than the threshold value, the DMA module does not send the second write command, instead ending the process without performing the operations at block 308. A DMA module that writes the status indicator to the target after a certain amount of data is written to the target can function similarly, with a register maintaining an indication of the amount of data that has been written.

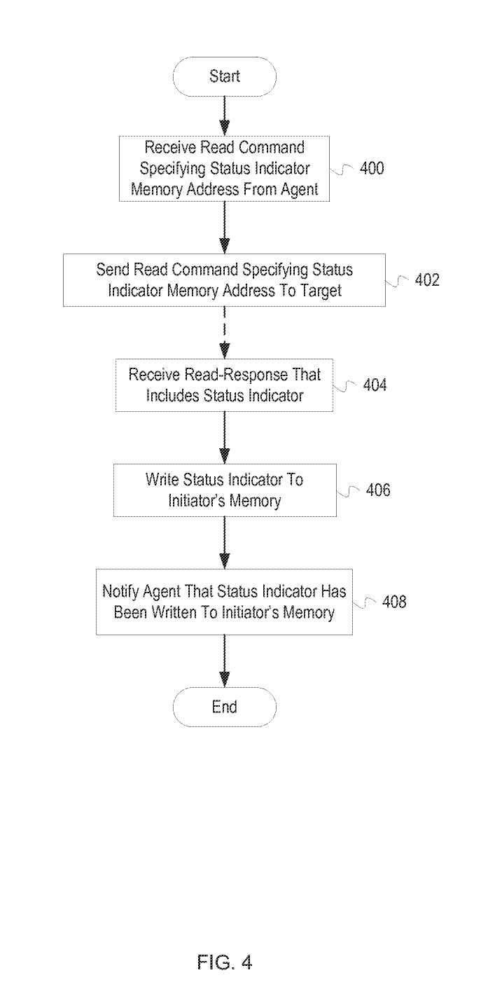

FIG. 4 depicts a flowchart of example operations for reading a status indicator from a target. The operations depicted in FIG. 4 can be performed by a DMA module, such as DMA module A 112 of FIG. 1, or any suitable component.

At block 400, a DMA module receives a read command from an agent. The read command specifies a source memory address and a destination memory address, as described above. The source memory address identifies the location in the target's memory at which the status indicator is stored. The destination memory address identifies the location in the initiator's memory to which the status indicator should be written. The destination memory address is stored in a buffer along with a read command identifier. The read command can include other metadata such as an initiator or agent identifier. The read command may be read from a queue associated with the DMA module or the agent. After the DMA module receives the read command from the agent, control then flows to block 402.

At block 402, the DMA module sends the read command to the target. The read command sent to the target includes the source memory address and the read command identifier. After the DMA module sends the status indicator read command to the target, control then flows to block 404.

At block 404, the DMA module receives a read-response and the associated status indicator from the target. The read-response includes a read command identifier that corresponds to the read command that the read-response is in response to. The DMA module uses the read command identifier to look the destination memory address up in a buffer. The destination memory address identifies the location in the initiator's memory to which the status indicator should be written. As indicated by the dotted line, the response can be received asynchronously. In other words, the DMA module may perform other operations after sending the read command (block 402) and prior to receiving the write command. After the DMA module receives the write command, control then flows to block 406.

At block 406, the DMA module writes the status indicator to the initiator memory. The DMA module writes the status indicator to the location identified by the destination memory address specified by the read command and referenced by the read-response (based on the read command identifier). After the DMA module writes the status indicator to the initiator memory, control then flows to block 408.

At block 408, the DMA module notifies the agent that the status indicator has been written to the initiator memory. The DMA module can notify the agent using inter-process messaging, interrupts, etc. The notification can identify the memory address at which the status indicator is located. After the DMA module notifies the agent that the status indicator has been written to the initiator memory, the process ends.

As described above in relation to FIG. 1, a DMA module can implement a status indicator read command. In such instances, instead of receiving a read command that specifies the status indicator memory address at block 400, the DMA module might receive the status indicator read command. The DMA module might then determine the appropriate source memory address and/or destination memory address itself.

As also described above, the agent can be implemented to periodically check the initiator memory for an updated status indicator. In such instances, the DMA module does not notify the agent that the status indicator has been written to the initiator memory (as depicted at block 408 of FIG. 4). The operations of FIG. 4 can be adapted accordingly.

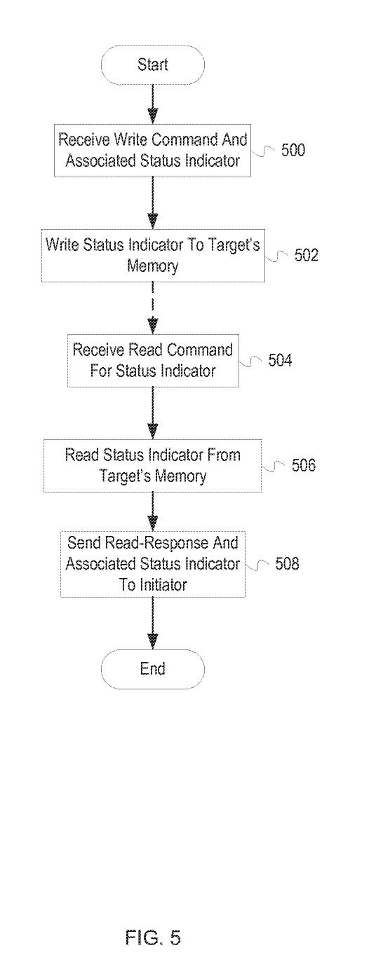

FIG. 5 depicts a flowchart of example operations for receiving a status indicator write command and a status indicator read command at a target. The operations depicted in FIG. 5 can be performed by a DMA module, such as DMA module B 122 of FIG. 1, or any suitable component.

At block 500, a DMA module receives a write command and an associated status indicator. The write command specifies a destination memory address that identifies the location in the target's memory to which the status indicator is written. The write command can include other metadata as well, such as the size of the status indicator, a component or agent identifier, etc. After the DMA module receives the write command and the associated status indicator, control then flows to block 502.

At block 502, the DMA module writes the status indicator to the target memory. In particular, the DMA module writes the status indicator to the location identified by the destination memory address. After the DMA module writes the status indicator to the target memory, control then flows to block 504.

At block 504, the DMA module receives a read command. As indicated by the dashed line, the command may be received asynchronously. In other words, the DMA module may perform other operations while waiting for the read command. The read command specifies a source memory address and a read command identifier, as described above. The source memory address identifies the location in the target's memory at which the status indicator is stored. The read command identifier is used by an initiating DMA module to identify the destination location for the status indicator. After the DMA module receives the read command, control then flows to block 506.

At block 506, the DMA module reads the status indicator from the target memory. In particular, the DMA module reads the status indicator from the location identified by the source memory address specified by the read command received at block 504. After the DMA module reads the status indicator from the target memory, control then flows to block 508.

At block 508, the DMA module sends a read-response and the status indicator to the initiator. The read-response includes the read command identifier specified by the read command received at block 504. After the DMA module sends the status indicator to the initiator, the process ends.

Status Indicator Echo Command Example Illustrations

The interactions between the source and targets can be reduced by introducing a status indicator echo command (hereinafter “echo command”). In the above illustrations, a DMA module on an initiator (hereinafter “initiating DMA module”) writes a status indicator to a target after the initiating DMA module writes a data block to the target. Then, an agent issues a read request, which is sent to the target. The target then sends the status indicator back to the initiating DMA module.

The echo command eliminates the agent issuing a read command in order to read the status indicator from the target. Instead, the initiating DMA module sends an echo command to the target. Similar to a write command for a status indicator, the echo command includes the status indicator. After receiving an echo command, a DMA module on the target (hereinafter “target DMA module”) writes the status indicator to the target memory, reads the status indicator back from the target memory, and sends the status indicator back to the initiating DMA module. In other words, instead of waiting for a subsequent read command, the target DMA module automatically sends the status indicator back to the initiating DMA module, which then writes the status indicator to the initiator memory. The echo command effectively combines the write command for the status indicator and the subsequent read command, eliminating not only the read command sent from the initiating DMA module to the target DMA module, but also eliminating the read command issued by the agent. Instead, the agent just reads the status indicator from the initiator memory, which always contains the most up-to-date status indicator.

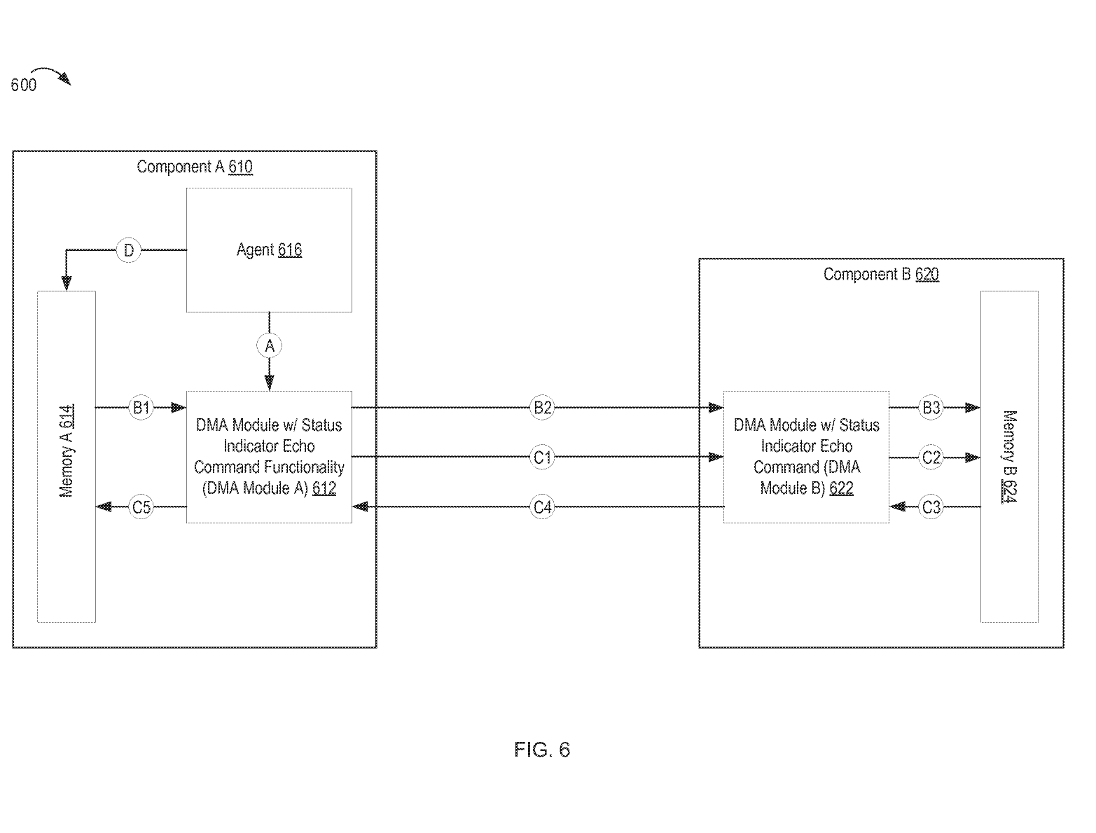

FIG. 6 depicts a direct memory access system including a DMA module with echo command functionality. FIG. 6 depicts a direct memory access system 600 including two components, component A 610 and component B 620. Component A 610 includes a DMA module with echo commands (hereinafter “DMA module A”) 612, memory A 614, and agent 616. Component B 620 includes a DMA module with echo commands (hereinafter “DMA module B”) 622 and memory B 624. DMA module A 612 and DMA module B 622 (hereinafter “DMA modules”) each implement one or more DMA protocol(s).

In this example, component A 610 functions as the initiator and component B 620 functions as the target. However, components can generally act as initiators and/or targets. Further, component A 610 and component B 620 can be components within a single computing system or can be individual computing systems themselves. For example, component A 610 might be a system bus controller on a motherboard and component B 620 might be a graphics card coupled to the motherboard via a PCI Express bus. As another example, component A 610 and component B 620 might be nodes of a distributed computing system coupled via the Internet. Component A 610 and component B 620 can be coupled with each other via a transmission medium (not depicted).

The particular technique used to identify an echo command can vary, and some variations are discussed below. For this particular example, the echo command mimics two write commands. In other words, the echo command is similar to a write command in which DMA module A 612 writes the status indicator to memory B 624 and similar to another write command in which DMA module B 622 writes the status indicator to memory A 614 in response to a command from DMA module A 612. However, in some instances, the DMA module B 622 can utilize a read-response (or similar mechanism) to send the status indicator back to DMA module A 612, mimicking a write command followed by a read command. The operations described below can be adapted accordingly.

In order to maintain semantics similar to read and write commands, the echo command is a write command that specifies a predetermined destination memory address. The predetermined destination memory address identifies the particular write command as an echo command. The particular predetermined memory address can be determined during DMA module initialization procedures.

Prior to actual DMA operations, DMA module A 612 and DMA module B 622 are initialized. During the initialization, the DMA modules “register” with each other. During the registration procedure (described in more detail below), the DMA modules determine the particular memory address that identify an echo command. For example, DMA module A 612 might determine that it will write the status indicator to memory address 0x05A. DMA module A 612 then notifies DMA module B 622 that the predetermined memory address is 0x05A, which DMA module B 622 stores for later use. When DMA module B 622 receives a write command, it compares the destination memory address indicated in the write command to the stored memory address that identifies the echo command. If the memory addresses match, DMA module B 622 determines that the command is an echo command and not an actual write command.

A similar scenario applies to the write command sent from DMA module B 622 to DMA module A 612 in response to the write command sent from DMA module A 612 to DMA module B 622 (i.e., the “echo” portion of the echo command). When the status indicator is echoed back to DMA module A 612, the status indicator is written to a predetermined memory address. DMA module A 612 can provide the predetermined memory address to DMA module B 622, which is stored. For the discussion below, it is assumed that DMA module B 622 has stored the relevant memory addresses. The memory address used to identify the echo command is referred to as the “destination memory address”. The memory address specified by the write command from DMA module B 622 in response to the echo command is referred to as the “initiator memory address”.

Stages A through D depict operations for use of a status indicator via an echo command. Stages A, B1, B2, and B3 can include operations substantially similar to those described above at stages A, B1, B2, and B3 of FIG. 1, respectively. In particular, at stage A, agent 616 issues a write command to DMA module A 612. At stage B1, DMA module A 612 reads a block of data identified by the write command from memory A 614. At stage B2, DMA module A 612 issues a write command to DMA module B 622 along with the block of data. At stage B3, DMA module B 622 writes the data block to the appropriate memory address in memory B 624.

Similar to stage C1 of FIG. 1, stage C1 can be performed after the completion of stage B2. Thus, stage C1 can be performed in parallel with stage B3. Further, in some instances, the echo command is not issued after every write command, instead being issued after a certain number of write commands are issued, a certain quantity of data is written, etc.

At stage C1, DMA module A 612 issues an echo command to DMA module B 622. The echo command includes the status indicator and the predetermined destination memory address. As with the status indicator described above, the status indicator generally indicates the completion state of the preceding write(s), and may specifically identify the preceding write command. For example, the status indicator might be a count of the number of write commands that have been completed or a unique identifier associated with the preceding write command. As with a write command, the echo command can include additional metadata, including the size of the status indicator, a component and/or agent identifier, etc.

At stage C2, DMA module B 622 receives and processes the echo command and writes the status indicator to the location in memory B 624 identified by the destination memory address. The echo command can be processed in a manner similar to a write command. In addition, DMA module B 622 determines that the echo command is, in fact, an echo command. To determine that the echo command is an echo command, the DMA module 622 compares the echo command destination memory address with the stored destination memory address. If the echo command destination memory address matches the stored destination memory address, the command is an echo command. Once the DMA module B 622 determines that the command is an echo command, DMA module B 622 writes the status indicator to the location in memory B 624 identified by the destination memory address.

At stage C3, DMA module B 622 reads the status indicator from memory B 624. The status indicator can be read in a substantially similar manner to that described above at stage E2 of FIG. 1.

At stage C4, DMA module B 622 issues a write command to DMA module A 612 along with the status indicator. The write command specifies the predetermined initiator memory address as the target address. As with the other write commands, the write command can include additional metadata, such as the size of the status indicator, component and/or agent identifiers, etc.

At stage C5, DMA module A 612 receives and processes the write command and writes the status indicator to the location in memory A 614 identified by the destination memory address (i.e., the initiator memory address).

At stage D, the agent 616 reads the status indicator from memory A 614. To read the status indicator from memory A 614, the agent 616 can perform similar operations to those described above at stage F of FIG. 1. For example, the agent 616 might read the status indicator from memory A 614 periodically until it determines that the status indicator indicates that the write command issued at stage A has been completed or DMA module A 612 might notify the agent 616 that the status indicator has been updated.

The direct memory access system 600 can vary similarly to the direct memory access system 100. For example, there may be multiple agents, targets, DMA modules, etc. The technique(s) described above can be adapted accordingly.

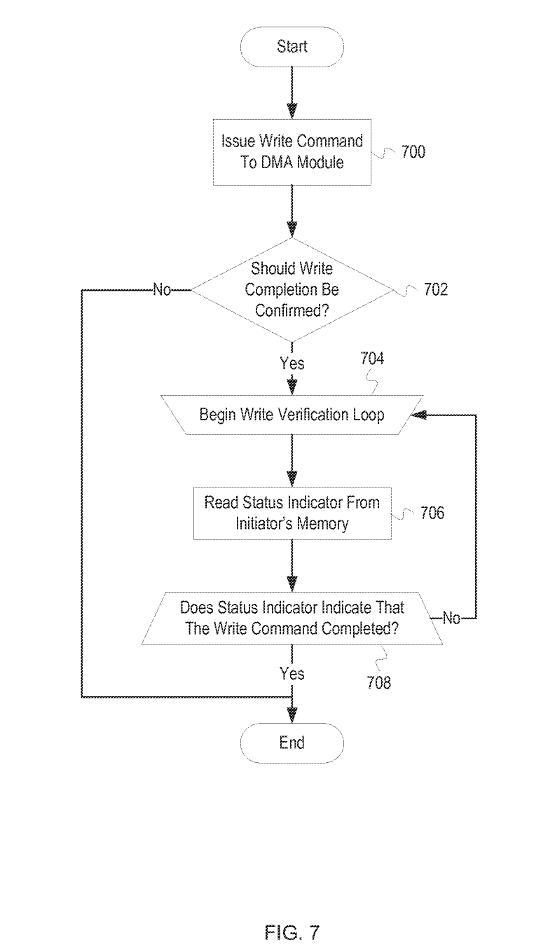

FIG. 7 depicts a flowchart of example operations for determining the current status indicator using an echo command. The operations depicted in FIG. 7 can be performed by an agent, such as the agent 616 depicted in FIG. 6, or any suitable component.

At block 700, an agent issues a write command to a DMA module. The operations performed at block 700 can be substantially similar to those performed at block 200 of FIG. 2. After the agent issues the write command to the DMA module, control then flows to block 702.

At block 702, the agent determines whether the write completion should be confirmed. The operations performed at block 702 can be similar to those performed at block 202 of FIG. 2. If the agent determines that the write completion should be confirmed, control then flows to block 704. If the agent determines that the write completion does not need to be confirmed, the process ends.

At block 704, a write verification loop begins. In the write verification loop, the agent periodically reads the status indicator from the initiator memory to determine whether the status indicator indicates that the write issued at block 700 has been completed. On each subsequent pass through block 704, the agent might wait for a time period, thereby allowing other operations to be performed for a particular length of time (e.g., ten milliseconds) or until notified by an interrupt or message before proceeding to block 706. After the write verification loop begins and/or the agent waits for the particular time period, control then flows to block 706.

At block 706, the agent reads the status indicator from the initiator memory. The operations performed at block 706 can be similar to those performed at block 208 of FIG. 2. After the agent reads the status indicator from the initiator memory, control then flows to block 708.

At block 708, the agent determines whether the status indicator indicates that the write command issued at block 700 has been completed. The particular operations performed to determine whether the write command has completed can vary. For example, if the status indicator indicates the number of write commands that have completed, the agent might keep track of the number of write commands issued. For example, assume that the write command issued at block 700 was the seventeenth write command issued. After a DMA module sends the seventeenth write command to a target, the status indicator becomes ‘17’. Thus, the agent can compare the status indicator read from the initiator memory to the count of write commands when the write command was issued at block 700. In this case, if the status indicator is ‘17’ or greater, the agent determines that the status indicator indicates that the write command issued at block 700 has completed. The specific operations performed by the agent can be adapted to other types of status indicators as appropriate. If the agent determines that the status indicator indicates that the write command issued at block 700 has been completed, the process ends. If the agent determines that the status indicator does not indicate that the write command issued at block 700 has been completed, control then flows back to block 704.

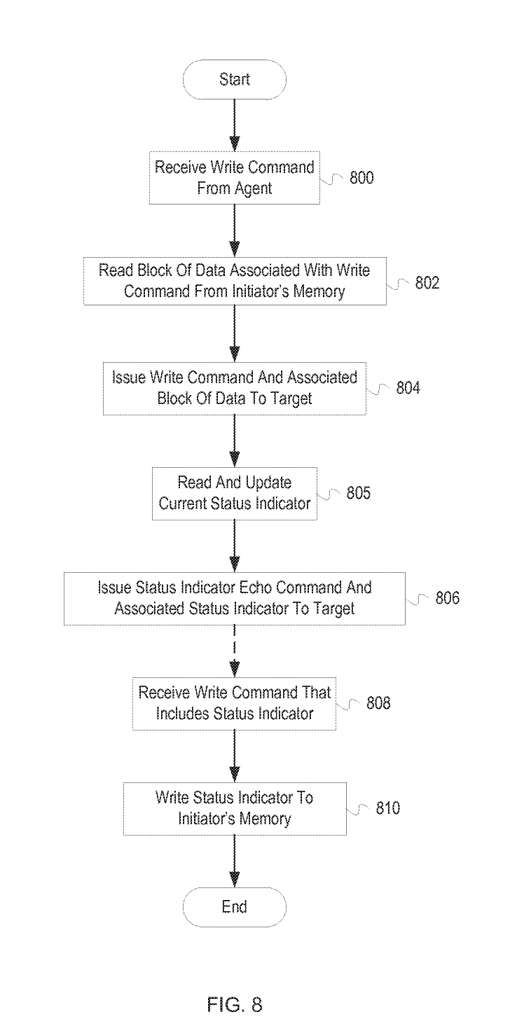

FIG. 8 depicts a flowchart of example operations for writing a data block and implementing an echo command. The operations depicted in FIG. 8 can be performed by a DMA module, such as DMA module A 612 of FIG. 6, or any suitable component.

At block 800, a DMA module receives a write command from an agent. The operations performed at block 800 can be similar to those performed at block 300 of FIG. 3. After the DMA module receives the write command from the agent, control then flows to block 802.

At block 802, the DMA module reads the block of data identified by the write command from the initiator memory. The operations performed at block 802 can be similar to those performed at block 302 of FIG. 3. After the DMA module reads the block of data identified by the write command from the initiator memory, control then flows to block 804.

At block 804, the DMA module issues the write command and the associated block of data to the target. The operations performed at block 804 can be similar to those performed at block 304 of FIG. 3. After the DMA module issues the write command and associated block of data to the target, control then flows to block 805.

At block 805, the DMA module updates the current status indicator. The operations performed at block 805 can be substantially similar to those performed at block 306 of FIG. 3. After the DMA module updates the status indicator, control then flows to block 806.

At block 806, the DMA module issues an echo command and an associated status indicator to the target. The echo command and the associated status indicator are sent in a manner similar to a write command. However, the echo command specifies the predetermined destination memory address, which identifies the command as an echo command. After the DMA module issues the echo command and the associated status indicator to the target, control then flows to block 808.

At block 808, the DMA module receives a write command that includes the status indicator. As indicated by the dashed line, the write command can be received asynchronously. In other words, the DMA module might perform other operations after sending the echo command and before receiving the write command. The write command specifies the initiator memory address. After the DMA module receives the response to the echo command, control then flows to block 810.

At block 810, the DMA module writes the status indicator to the initiator memory. The operations performed at block 810 can be similar to those performed at block 406 of FIG. 4. After the DMA module writes the status indicator to the initiator memory, the process ends.

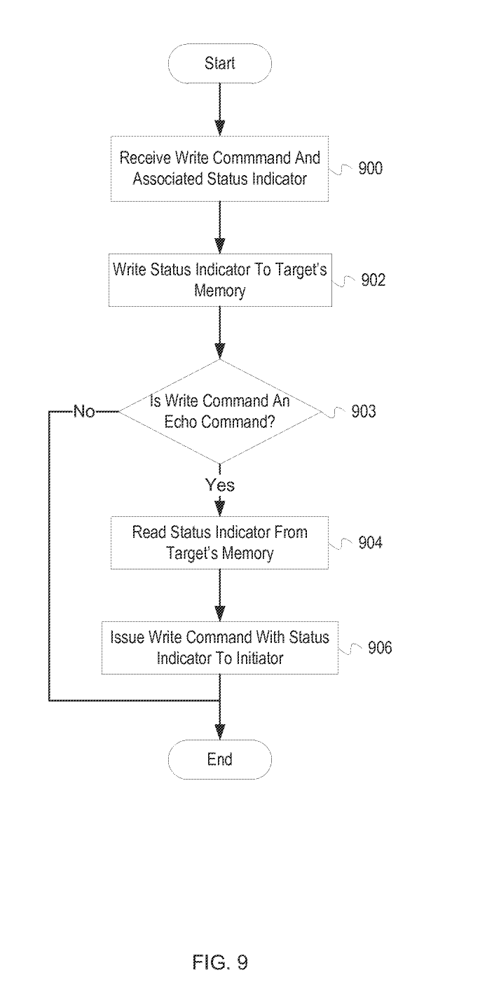

FIG. 9 depicts a flowchart of example operations for receiving an echo command at a target. The operations depicted in FIG. 9 can be performed by a DMA module, such as DMA module B 622 of FIG. 6, or any suitable component.

At block 900, a DMA module receives a write command and an associated status indicator. The write command received can be substantially similar to the echo command described above at block 806 of FIG. 8. As discussed above, the echo command is a write command that specifies a predetermined destination memory address. After the DMA module receives the write command, control then flows to block 902.

At block 902, the DMA module writes the status indicator to the target memory. The DMA module writes the status indicator to the destination memory address as stored or indicated in the echo command. After the DMA module writes the status indicator to the target memory, control then flows to block 903.

At block 903, the DMA module determines whether the write command is an echo command. To determine whether the write command is an echo command, the DMA module compares the destination memory address specified by the write command to a stored destination memory address. The stored destination memory address was previously stored in response to another DMA module indicating that a particular destination memory address identifies an echo command. The stored destination memory address can be stored in a register or other memory location accessible to the DMA module. If the write command destination memory address matches the stored destination memory address, the write command is an echo command. If the DMA module determines that the write command is an echo command, control then flows to block 904. If the DMA module determines that the write command is not an echo command, the process ends.

At block 904, the DMA module reads the status indicator from the target memory. The operations performed at block 904 can be similar to those described at block 506 of FIG. 5. After the DMA module reads the status indicator from the target memory, control then flows to block 906.

At block 906, the DMA module issues a write command and the associated status indicator to the initiator. The write command specifies the initiating memory address as the location to write the status indicator. After the DMA module sends the status indicator to the initiator, the process ends.

As mentioned above, aspects of the disclosures can vary. An initiator DMA module might interface with multiple agents and a target DMA module might store multiple initiator memory addresses and destination memory addresses. Similarly, there may be multiple initiator and/or target DMA modules.

When the target DMA module stores a destination memory address for use in detecting an echo command, the particular destination memory address is known to both the initiator DMA module and target DMA module (i.e., is “agreed” upon). The determination of the particular destination memory address can occur during an initialization or configuration process.

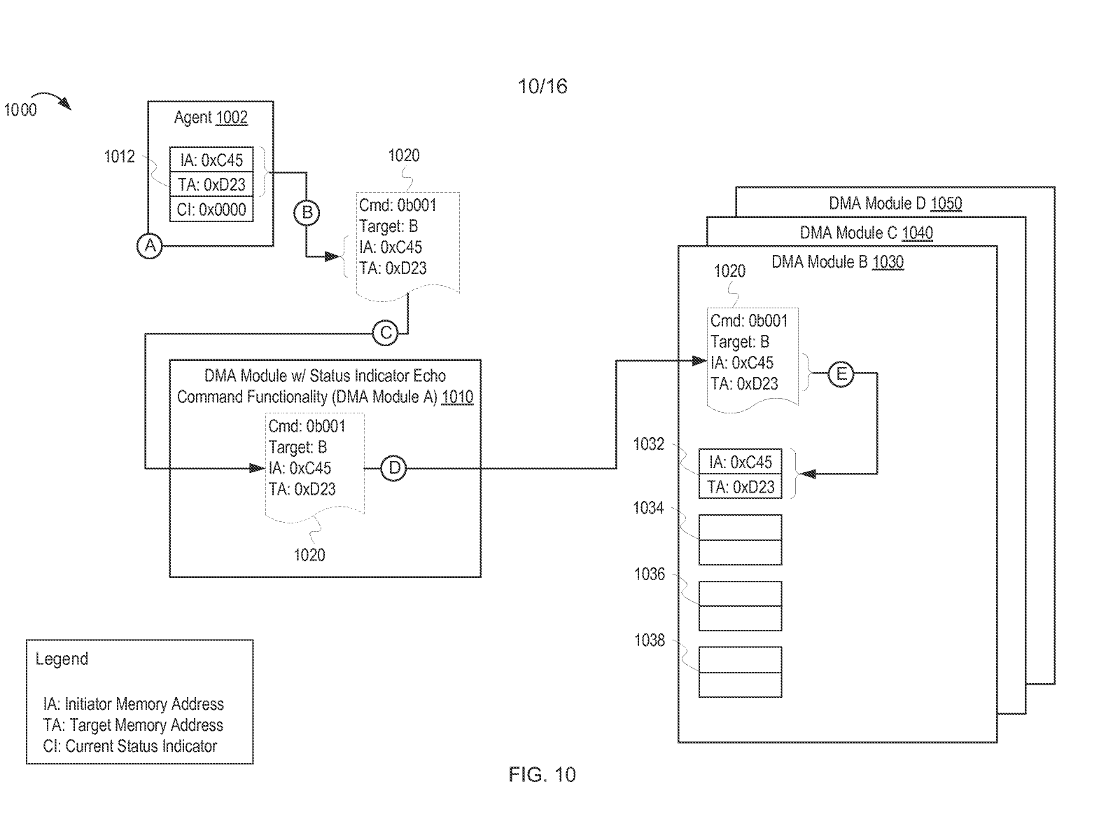

FIG. 10 depicts a direct memory access system including a DMA module with echo command functionality. FIG. 10 depicts a direct memory access system 1000 including agent 1002, DMA module with echo command functionality (hereinafter “DMA module A”) 1010, DMA module B 1030, DMA module C 1040, and DMA module D 1050. DMA module B 1030, DMA module C 1040, and DMA module D 1050 also implement status indicator echo command functionality. The agent 1002 maintains status indicator metadata 1012, which includes an initiator memory address, destination memory address, and a current status indicator. DMA module B 1030 includes four sets of metadata storage, 1032, 1034, 1036, and 1038. The storage for the metadata can be one or more registers, locations in memory, etc. Each set of metadata stored within DMA module B 1030 includes an initiator memory address and a destination memory address. In this example, DMA module A 1010 functions as an initiator DMA module and DMA module B 1030 functions as a target DMA module. The direct memory access system 1000 can include additional components, such as those depicted in FIG. 1.

At stage A, the agent 1002 initializes the status indicator metadata 1012. The particular initialization process can vary. To determine the initiator memory address, the agent 1002 can identify a particular memory location that is accessible to both the agent 1002 and DMA module A 1010. For example, the agent 1002 might request a particular memory location from an operating system (not depicted) or might indicate to the operating system that a particular memory location within the agent's address space should be made accessible to DMA module A 1010. In this particular example, the initiator memory address is ‘0xC45’.

Determining the destination memory address can include requesting a reserved memory location from DMA module B 1030 or determining a particular memory location on the target that is accessible to the agent 1002. In this particular example, the destination memory address is ‘0xD23’.

The current status indicator might be initialized to zero or to a particular transaction identifier. In this particular example, the current status indicator is maintained as a sequential integer counter, and is thus initialized to zero (‘0x0000’).

At stage B, the agent 1002 generates a status indicator configuration command 1020. The status indicator configuration command 1020 is identified by the value 0b001 (hereinafter “command identifier”). The command identifier is a predetermined identifier that is specified, typically, as part of the DMA protocol, similar to a command identifier for a write command or read command. The particular command identifier selected can vary based on the type of command identifiers used by a particular protocol, which command identifiers are already in use, etc. The status indicator configuration command 1020 also identifies the particular target DMA module and includes the initiator memory address and destination memory address (hereinafter “command parameters”). In this example, DMA module B 1030 is the target DMA module.

At stage C, the agent 1002 issues the status indicator configuration command 1020 to DMA module A 1010. To issue the status indicator configuration command 1020, the agent 1002 sends the command identifier and command parameters to DMA module A 1010. The agent 1002 can communicate with DMA module A 1010 via function calls, inter-process messaging, etc.

At stage D, DMA module A 1010 identifies the target DMA module and transmits the status indicator configuration command 1020 to DMA module B 1030. To identify the target DMA module, DMA module A 1010 reads the “target” field from the command. In this particular instance, the target field is ‘B’, indicating DMA module B 1030 as the target DMA module. Once the target DMA module is identified, DMA module A 1010 sends the status indicator configuration command 1020 to DMA module B 1030. DMA module A 1010 can send the status indicator configuration command 1020 to DMA module B 1030 in a substantially similar manner to that used to send an echo command, as described above.

At stage E, DMA module B 1030 receives and processes the status indicator configuration command 1020. To process the status indicator configuration command 1020, DMA module B 1030 identifies the status indicator configuration command 1030 by reading the “cmd” field. DMA module B 1030 then extracts the initiator memory address and destination memory address, storing the initiator memory address and destination memory address into metadata storage 1032. In this particular example, the initiator memory address (‘0xC45’) and the destination memory address (‘0xD23’) are stored in the metadata storage 1032.

Once the initiator memory address and destination memory address is written to the metadata storage 1032, the agent 1002 has effectively registered an echo command and can begin issuing echo commands. In some instances, DMA module A 1010 also stores the initiator memory address and destination memory address. Additionally, in some instances, the agent 1002 does not generate and issue the status indicator configuration command 1020; instead, DMA module A 1010 generates and issues the status indicator configuration command 1020.

In some instances, the registration of the identifier can be performed at any time. Thus, the registration need not occur during an initialization or configuration phase, but can occur during normal operation. Similarly, in some instances, the agent 1002 can update the metadata by sending another status indicator echo configuration command with the same destination memory address. In some instances, the agent 1002 can register multiple target/initiator memory addresses with a single target DMA module.

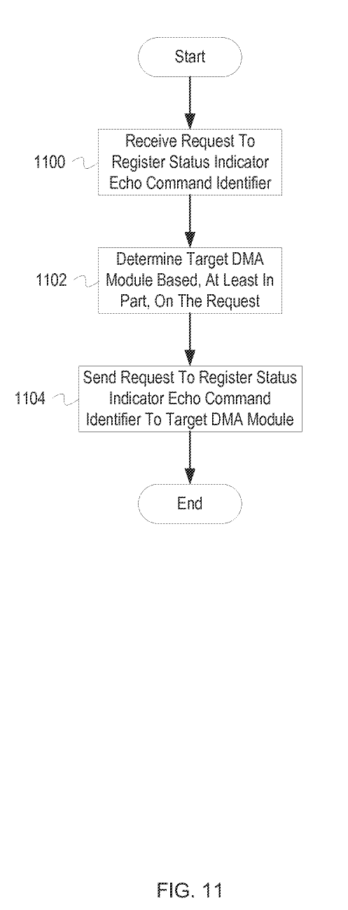

FIG. 11 depicts a flowchart of example operations for receiving a request to register an echo command identifier by an initiator DMA module. The operations depicted in FIG. 11 can be performed by a DMA module, such as DMA module A 1010 in FIG. 10, or any suitable component.

At block 1100, a DMA module receives a request to register an echo command identifier (hereinafter “identifier”) from an agent. The request identifies the particular identifier and can include additional echo command metadata, such as an initiator memory address and destination memory address. Additionally, the request identifies a target DMA module (if there are multiple target DMA modules) that the identifier should be registered with. In some instances, the request can identify multiple target DMA modules. After the DMA module receives the request to register the identifier, control then flows to block 1102.

At block 1102, the DMA module determines the target DMA module based, at least in part, on the request to register the identifier. To determine the target DMA module, the DMA module reads a field containing a target DMA module identifier. In some instances, the target DMA module identifier can be used directly. In some instances, the DMA module looks up an address or other identifier used to actually communicate with the identified target DMA module. After the DMA module determines the target DMA module, control then flows to block 1104.

At block 1104, the DMA module sends the request to register the identifier to the target DMA module. The request can be the same as the request received at block 1100 or can be modified. For example, the DMA module might not include a target DMA module identifier in the request sent to the target DMA module. After the DMA module sends the request to register the identifier to the target DMA module, the process ends.

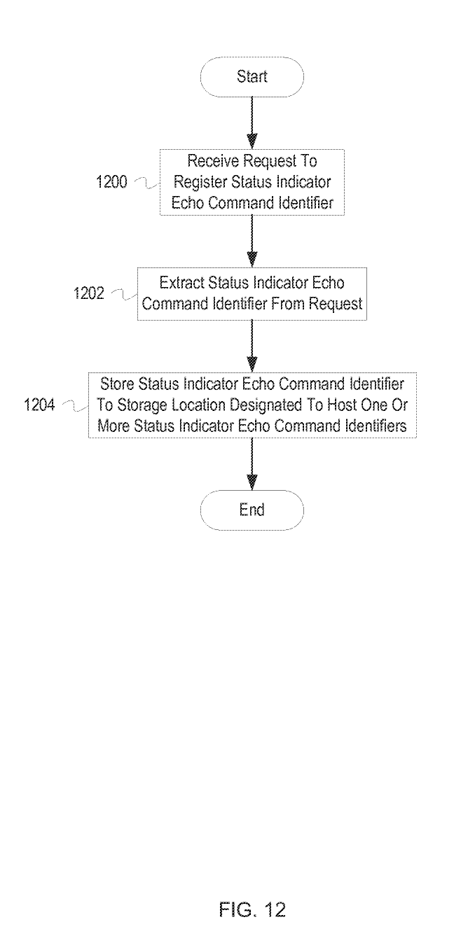

FIG. 12 depicts a flowchart of example operations for receiving a request to register an echo command identifier by a target DMA module. The operations depicted in FIG. 12 can be performed by a DMA module, such as DMA module B 1030 in FIG. 10, or any suitable component.

At block 1200, a DMA module receives a request to register an echo command identifier (hereinafter “identifier”) from an initiator DMA module. The request can be substantially similar to that described above at block 1100 of FIG. 11. After the DMA module receives the request to register the identifier, control then flows to block 1202.

At block 1202, the DMA module extracts the identifier from the request to register the identifier. To extract the identifier from the request, the DMA module reads data from a field associated with the identifier. As described above, the request can include additional echo command metadata, which can be extracted by the DMA module as well. The identifier can also be a part of the metadata. After the DMA module extracts the identifier from the request to register the identifier, control then flows to block 1204.

At block 1204, the DMA module stores the identifier to a storage location designated to host one or more identifiers. The storage location can be a register or particular location in memory. The storage location can be a group of storage locations that can store multiple identifiers in a data structure such as a table. If the request included additional echo command metadata, the DMA module can similarly store the additional metadata in appropriate storage locations. After the DMA module stores the identifier to the storage location designated to host one or more identifiers, the process ends.

Although FIGS. 11 and 12 depict an initiator DMA module sending a command to register a particular echo command identifier, a target DMA module might dictate the echo command identifier to the initiator DMA module. For example, the initiator DMA module might request an echo command identifier from a target DMA module. Additionally, the registration process may be performed as depicted in FIGS. 11 and 12 but with the roles of the initiator DMA module and target DMA module reversed. As described above, DMA modules can be both initiators and targets; thus, whether a particular DMA module is an initiator or target can be independent from the DMA module's role in registering an echo command identifier.

DMA modules can implement a deregistration process as well. The deregistration process can be similar to the registration request process described above. For example, an initiator DMA module may send a request similar to the one sent at block 1104 but identifying the request as a “deregister” request instead of a “register” request.

Once an agent “registers” an identifier with a target DMA module, the agent can issue echo commands to the target DMA module. The agent generates an echo command that includes the registered identifier. If, for example, the echo command is implemented using a write command, the agent generates a write command that includes the destination memory address registered with the target DMA module as the address to write to. The write command also includes the current status indicator.

Accordingly, when a target DMA module receives a write command, the target DMA module compares the memory address indicated in the write command with the stored identifiers (assuming multiple identifiers have been registered). If the memory address matches one of the stored identifiers, the target DMA module determines that the write command is, more particularly, an echo command. The target DMA module then tracks the completion state of the echo command. Once prior writes have been completed, the target DMA module generates a write command that includes the status indicator as the data to write. The target DMA module determines the appropriate memory address to include in the write command based on the destination memory address identified by the echo command. The generated write command is sent back to the initiator DMA module.

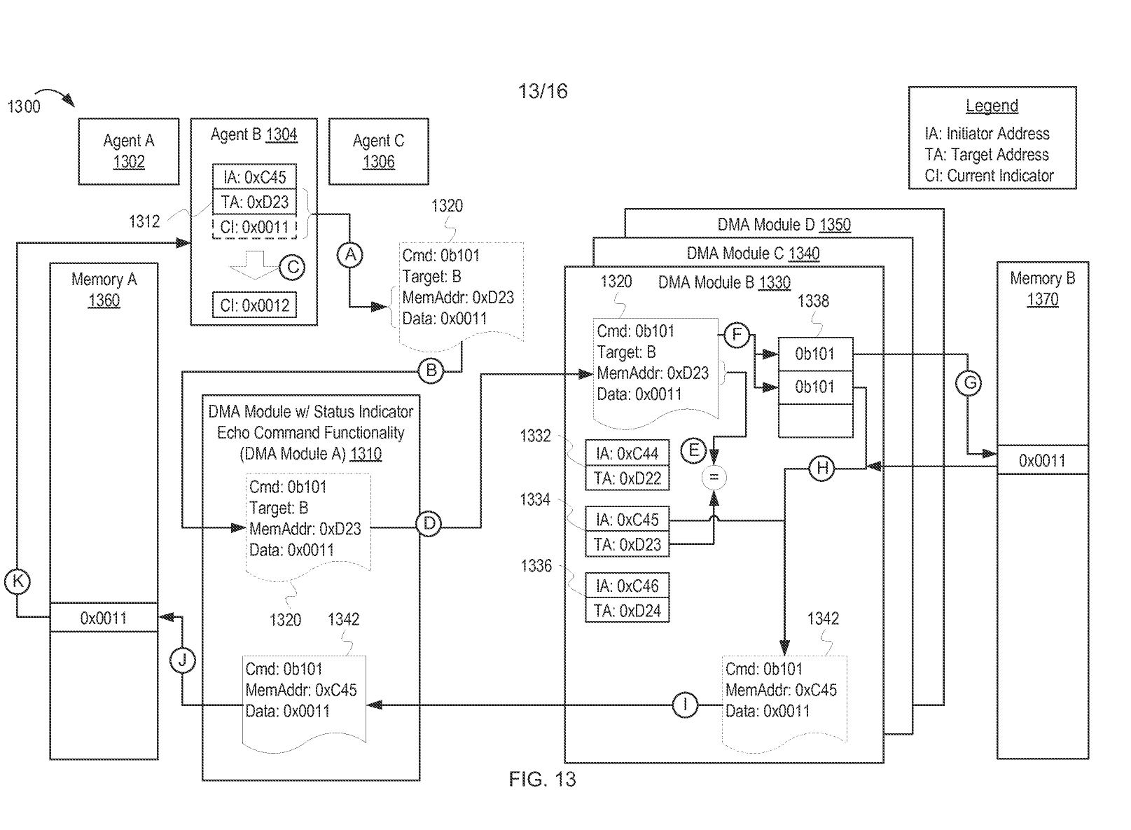

FIG. 13 depicts a direct memory access system including a DMA module with echo command functionality. FIG. 13 depicts a direct memory access system 1300 including agent A 1302, agent B 1304, and agent C 1306. The direct memory access system 1300 also includes DMA module with echo command functionality (hereinafter “DMA module A”) 1310 (functioning as an initiator DMA module), DMA module B 1330 (functioning as a target DMA module), DMA module C 1340, and DMA module D 1350. The direct memory access system 1300 also includes memory A 1360 and memory B 1370. DMA module A 1310 is coupled with memory A 1360 and DMA module B 1330 is coupled with memory B 1370. DMA module B 1330, DMA module C 1340, and DMA module D 1350 each include status indicator echo command functionality as well.

FIG. 13 depicts the direct memory access system 1300 in a state after each agent has registered a target and initiator memory address with DMA module B 1330. Agent B 1304 maintains metadata 1312, which includes initiator memory address ‘0xC45’, destination memory address ‘0xD23’, and current status indicator ‘0x0011’. The status indicator is a sequentially increasing integer, thus indicating that two echo commands have been sent. This assumes that memory is initialized to 0x0000, thus resulting in agent B 1304 skipping the initial 0x0000 value of the current status indicator.

Pursuant to the registration of the identifiers, DMA module B 1330 has three sets of metadata stored, 1332, 1334, and 1336. Metadata 1332 corresponds to agent A 1302, metadata 1334 corresponds to agent B 1304, and metadata 1336 corresponds to agent C 1306. Accordingly, the initiator memory address and destination memory address in metadata 1334 correspond to the initiator memory address and destination memory address in metadata 1312 (‘0xC45’ and ‘0xD23’, respectively).

At stage A, agent B 1304 generates an echo command 1320 using the metadata 1312. Similar to creating a status indicator echo configuration command, as described above, agent B 1304 includes a command identifier and a target DMA module identifier (in this example, ‘0b101’ and ‘B’, respectively). Additionally, agent B 1304 includes the memory address to write the data to. In this case, agent B 1304 uses the destination memory address from the metadata 1312 (‘0xD23’). Agent B 1304 includes the current status indicator (‘0x0011’) as the data to write.

At stage B, agent B 1304 issues the echo command 1320 to DMA module A 1310. As described above, the echo command 1320 is issued by sending the command identifier and command parameters to DMA module A 1310. Agent B 1304 can communicate with DMA module A 1310 via function calls, inter-process messaging, etc.

At stage C, agent B 1304 updates the current status indicator in the metadata 1312. Because the currents status indicator is a sequentially increasing integer, agent B 1304 increments the current status indicator by one. In some instances, the current status indicator can be updated at a later point, such as after agent B 1304 reads the status indicator from memory A 1360 (described at stage K). However, updating the current status indicator prior to reading the status indicator from memory A 1360 allows agent B 1304 to send another status indicator sooner.

At stage D, DMA module A 1310 determines the target for the echo command 1320 and issues the echo command 1320 to the determined target. To determine the target, DMA module A 1310 reads data associated with the target field. In this example, DMA module A 1310 determines that the target field identifies DMA module B 1330 as the target (based on the ‘B’ identifier). Once DMA module A 1310 has determined that DMA module B 1330 is the target DMA module of the echo command 1020, DMA module A 1310 issues the echo command 1020 to DMA module B 1330.

At stage E, DMA module B 1330 identifies the echo command 1320 as a write command and compares the memory address identified in the echo command 1320 with the stored echo command identifier metadata. In particular, DMA module B 1330 determines that the echo command 1320 includes command identifier ‘0b101’, which corresponds to a write command. DMA module B 1330 then reads the memory address from the memory address field and compares it to the destination memory address in the stored metadata 1332 1334, and 1336. DMA module B 1330 can stop comparing the memory address with the destination memory addresses in the metadata when a match is found. If no match is found, DMA module B 1330 determines that the write command is not an echo command. In this particular example, the memory address identified in the echo command 1320 is the destination memory address corresponding to the destination memory address for agent B 1304. Thus, DMA module B 1330 determines that the echo command 1320 is, in fact, an echo command based on determining that the memory address is the same as the destination memory address in metadata 1334.

At stage F, DMA module B 1330 inserts an indication of the write command received from DMA module A 1310 (a local write) and an indication of a write command to send to DMA module A 1310 (a remote write) into a command queue 1338. The command queue 1338 is a mechanism used by DMA module B 1330 to maintain command ordering. The command queue 1338 can be a standard first-in first-out queue, a priority queue, etc. If the command queue 1338 supports reordering (e.g., is a priority queue), the DMA module B 1330 ensures that ordering with respect to the status indicator write commands is maintained. The indication of the remote write command is inserted behind the indication of the write command.

The indications of the write commands typically include an indication of the command type and relevant memory addresses (e.g., memory address to write data to or read data from). In this example, the indications of the write commands also include metadata identifying the particular command as a local write or remote write. In some instances, the command identifiers used by the DMA module B 1330 internally (e.g., to identify commands in the command queue 1338) differ from those used by the actual DMA protocol.

Stage G occurs after the indication of the local write command reaches the head of the command queue 1338. At stage G, DMA module B 1330 performs operations to carry out the local write command. In particular, DMA module B 1330 writes the data associated with the local write command to the memory address of memory B 1370 specified by the local write command (and echo command 1320). The indication of the local write command is removed from the command queue 1338 when appropriate (i.e., before or after performing the local write command itself).

Stage H occurs after the indication of the remote write command reaches the head of the command queue 1338. At stage H, DMA module B 1330 performs operations to carry out the remote write command. In particular, DMA module B 1330 reads the data from the memory address of memory B 1370 specified by the remote write command (and echo command 1320).

To effectuate a remote write command, a target DMA module writes the read data back to the memory associated with the initiator DMA module. Thus, DMA module B 1330 generates write command 1342. Write command 1342 includes a command identifier (‘0b101’, like the echo command 1320), a memory address, and the data to write. When created in response to an echo command, the write command 1342 uses the initiator memory address stored in the metadata 1334 (i.e., the initiator memory address registered by agent B 1304). As described above at stage F, the initiator memory address is included with the indication of the remote write command that is inserted into the command queue 1338.

At stage I, DMA module B 1330 issues the write command 1342 to DMA module A 1310. DMA module B 1330 can send the write command 1342 in substantially the same manner as the other commands described above.

At stage J, DMA module A 1310 receives the write command 1342 and writes the data associated with the write command 1342 to memory A 1360. In particular, DMA module A 1310 determines that the write command 1342 is, in fact, a write command by reading the command identifier field and determining that the command identifier indicates a write command. DMA module A 1310 also reads the memory address from the memory address field and writes the data to the memory location in memory A 1360 associated with the memory address.

At stage K, agent B 1304 reads the status indicator from memory A 1360. In particular, agent B 1304 reads the data at the memory location identified by the initiator memory address specified in the metadata 1312.

As described above, agent B 1304 might read the status indicator periodically until agent B 1304 determines that it indicates the appropriate status indicator. Agent B 1304 might thus maintain additional metadata, such as a list of status indicators sent to DMA module B 1330 that have not been written to memory A 1360.

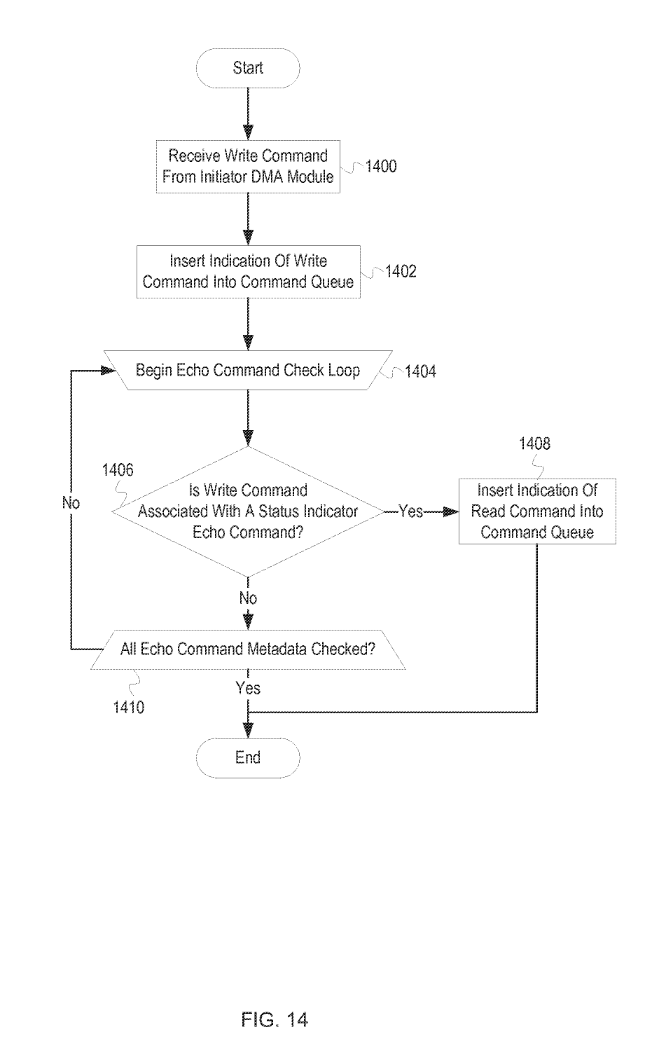

FIG. 14 depicts a flowchart of example operations for processing an echo command by a target DMA module using a registered destination memory address. The operations depicted in FIG. 14 can be performed by a DMA module, such as DMA module B 1330 in FIG. 13, or any suitable component.

At block 1400, a DMA module receives a write command from an initiator DMA module. The write command includes at least a command identifier, a memory address indicating a location to write data to, and data to write. After the DMA module receives the write command from the initiator DMA module, control then flows to block 1402.

At block 1402, the DMA module inserts an indication of the write command into a command queue. The indication of the write command includes a command identifier, the memory address to write the data to, and the data to write or a pointer to the data to write. After the DMA module inserts an indication of the write command into the command queue, control then flows to block 1404.

At block 1404, the DMA module begins loop in which the DMA module determines whether the write command is associated with an echo command. During the loop, the DMA module iterates through one or more previously stored sets of metadata that identifies one or more memory addresses as being echo command identifiers. On the first pass through block 1404, the DMA module selects a first set of the stored metadata as the current metadata and initializes any loop metadata used to facilitate the loop, such as a counter. On subsequent passes through block 1404, the DMA module selects a previously unselected set of the stored metadata as the current metadata and updates the loop metadata as appropriate. After the DMA module initializes or updates current metadata and loop metadata, control then flows to block 1406.

At block 1406, the DMA module determines whether the current metadata indicates that the write command is associated with an echo command. The current metadata might, for example, include a destination memory address that identifies which write commands are associated with echo commands. Thus, the DMA module might compare a destination memory address indicated in the current metadata with the memory address included in the write command. The specific operations performed by the DMA module can vary according to the particular metadata used to indicate which write commands are associated with echo commands. If the DMA module determines that the current metadata indicates that the write command is associated an echo command, control then flows to block 1408. If the DMA module determines that the current metadata does not indicate that the write command is associated with an echo command, control then flows to block 1410.

At block 1408, the DMA module inserts an indication of a remote write command into the command queue. The remote write command includes a command identifier, a memory address indicating the data to be read and a memory address indicating the location the data should be written to. In some instances, the memory address indicating the location the data should be written to is determined from the current metadata. For example, in some instances, the current metadata includes a destination memory address that identifies echo commands and an initiator memory address that identifies the memory location on an initiator component that the status indicator should be written to. Thus, the DMA module includes the initiator memory address as part of the indication of the remote write command. After the DMA module inserts the indication of the remote write command into the command queue, the process ends.

Control flowed to block 1410 if it was determined, at block 1406, that the write command is not associated with an echo command. At block 1406, determines whether all sets of the stored metadata have been iterated over. If all of the sets of stored metadata have not been iterated over, control then flows back to block 1404. If all of the sets of stored metadata have been iterated over, the process ends.

It is assumed that the command queue is a first-in first-out queue. The operations described above can adapted for other types of queues, such as priority queues or other queues that allow reordering of queue elements. For example, the DMA module might perform additional operations, such as scanning the command queue, to determine where in the command queue the indications should be inserted.

In instances in which echo commands are identified in other ways, the operations performed by the DMA module can be adapted accordingly. For example, if echo commands are identified by a particular command, the DMA module can determine that a received command is an echo command by determining that the command identifier indicates that the received command is, in fact, an echo command.

The operations of the other components depicted in FIG. 13, such as agent B 1304 and DMA module A 1310 can be similar to those described above. Where FIG. 13 depicts particular features not otherwise described earlier, related operations can be adapted accordingly.

Although the examples described focused on DMA protocols, the disclosures herein can apply to other protocols as well. For example, similar techniques can be applied to some or all protocols that do not include explicit confirmation that data has been received or that write operations have completed. Further, PCI-Express and RDMA are only two examples of possible DMA protocols.

As described above, read and write commands might operate on fixed- or variable-sized blocks of data. The specific values used to identify the location(s) at which data is to be written or from which data is read from can vary accordingly. For example, when operating on fixed-sized blocks of data, the particular location at which the data is stored can be identified by the memory address associated with the beginning of the location. Thus, the memory addresses extending beyond the identified memory address are implied based on the size of the data block. When operating on variable-sized blocks of data, the particular location at which the data is stored can be identified by the memory address associated with the beginning of the location as well as an indication of the size of the data block. For example, the size of the data block might be specified as a number of bytes in the data block (e.g., four kilobytes). The size of the data block might also be delineated by specifying the memory address associated with the beginning of the location as well as the end of the location.

Further, the memory accessible to a particular component for reading or writing via a DMA protocol might be a subset of the memory of the source or target. In other words, directly writing data to the memory of a particular component might be limited to a particular set of locations within that memory. Relatedly, the memory addresses can be specified absolutely or relatively. For example, if the range of memory addresses available for DMA operations is 0xD00 through 0xDFF, the memory addresses used to reference the locations might be the memory addresses between 0xD00 and 0xDFF, resulting in absolute memory addresses. Relative memory addresses for the same range, on the other hand, might be 0x000 through 0x100. Thus, memory address 0x000 would correspond to memory address 0xD00, 0x001 would correspond to memory address 0xD01, etc.

Further, a memory address is just an example of a potential target descriptor or source descriptor. A target descriptor is metadata that indicates where data should be written to. Similarly, a source descriptor is metadata that indicates where data should be read from. While usually functionally similar to a memory address, a target descriptor/source descriptor does not necessarily have to be a memory address, but can be any type of data that indicates a particular location.

As mentioned above, the technique used to identify an echo command can vary. The example above used a predetermined memory address to differentiate a write command from an echo command. In some instances, the echo command can be defined as a unique command. For example, a particular protocol might identify commands based on a particular value that is sent between components. For example, a read command might be 0b00, while a write command might be 0b01. The echo command can be added as a new command identified by a unique value. Thus, instead of comparing the memory address identified by the command, a DMA module might instead determine the command type based on the value identifying the command itself.

Additionally, the example above described the target DMA module as storing the destination memory address and the initiator memory address. In some instances, however, the initiator DMA module might specify both the destination memory address and the initiator memory address with the echo command. Thus, the initiator DMA module can vary the initiator memory address, providing additional flexibility. Similarly, the initiator DMA module might store the initiator memory address, which would then not need to be specified when the status indicator is echoed to the initiator component.

An assumption made in the examples above is that commands are performed by the respective DMA module in the order in which they are received. It is, however, possible for DMA modules to reorder certain commands. For example, read commands and write commands that reference distinct locations (i.e., non-overlapping writes) can be reordered. Because an echo command indicates that the writes issued prior to the echo command have completed, the echo command generally cannot be reordered with respect to the preceding writes. Also, writes of metadata that reference data written separately generally cannot be reordered with respect to those separate writes. Thus, DMA modules might implement additional logic to ensure that selected (or all) commands are not performed out of order with respect to other specified commands. Further, a DMA module might not actually write the status indicator to memory. Instead, the DMA module might track the preceding write commands and write the status indicator back to the initiator component after determining that the preceding write commands have been completed.

As mentioned above, the particular choice for a status indicator can vary. The examples given above include an indication of the number of write commands completed and an identifier associated with the preceding write command. Status indicators can be more complex as well. For example, a status indicator might be a transaction identifier that identifies a specific set of write commands and might be generated by the agent or the DMA module.

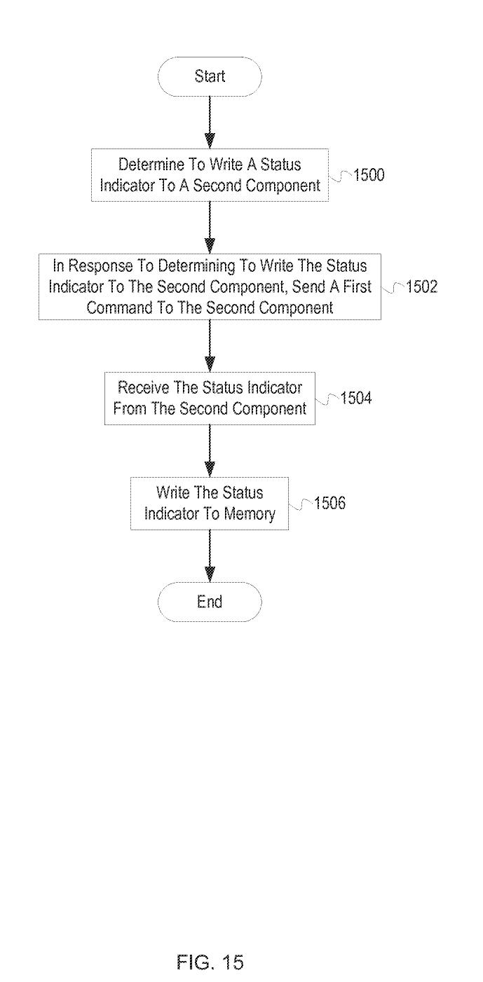

FIG. 15 depicts a flowchart of example operations for using cross-component status indicators. The operations depicted in FIG. 15 apply to components that implement cross-component status indicators using write commands or echo commands. The operations depicted in FIG. 15 can be performed by a component, such as component A 110 in FIG. 1, or any suitable component.

At block 1500, a first component determines to write a status indicator to a second component. The first component might determine that the status indicator should be written to the second component if the completion of a particular write operation should be verified, a particular number of write operations have been issued, a particular amount of data has been written, in response to an indication from another component, etc. After the component determines to write the status indicator to the second component, control then flows to block 1502.

At block 1502, the first component sends a first command to the second component in response to determining to write the status indicator to the second component. The first command includes at least the status indicator. The first command can be a write command, an echo command, or any other type of command that includes the status indicator. The first command can also include an indication of a first memory location. After the first component sends the first command to the second component, control then flows to block 1504.

At block 1504, the first component receives the status indicator from the second component. The status indicator can be received as part of a write command, echo command response, or other command/response/message. The status indicator might be sent from the second component to the first component in response to a read command, echo command, or other command issued by the first component. After the first component receives the status indicator from the second component, control then flows to block 1506.

At block 1506, the first component writes the status indicator to memory. The particular location in memory is typically identified by a memory address, which can be received from the second component at block 1504 along with the status indicator. The first component might determine the particular location based on metadata stored by the first component or specified by another component. After the first component writes the status indicator to memory, the process ends.

As example flowcharts, FIGS. 2-5, 7-9, 11, 12, 14, and 15 present operations in an example order from which storage systems can deviate (e.g., operations can be performed in a different order than illustrated and/or in parallel; additional or fewer operations can be performed, etc.). For example, while FIG. 9 depicts a status indicator being written to a target memory before determining that an associated write command is an echo command, the DMA module might determine that the write command is an echo command first.

Further, loops depicted in the flowcharts may terminate at various points prior to completion of the loops. For example, a node might encounter an error while performing the operations of the loop depicted at blocks 704-708 of FIG. 7 that causes the loop to terminate prior to the determining that the status indicator indicates that the write command completed. This can be in addition to other operations depicted that result in early termination of the loop. Similarly, loops identified as “for each” loops might terminate prior to each element being iterated over. In general, some operations not directly pertinent to the disclosures herein have not been depicted, and some of these operations might result in the processes depicted in the flowcharts terminating early.

As will be appreciated by one skilled in the art, aspects of the disclosures herein may be embodied as a system, method or computer program product. Accordingly, aspects of the disclosures herein may take the form of hardware, software (including firmware, resident software, micro-code, etc.) or a combination of software and hardware aspects that may all generally be referred to herein as a “circuit,” “module” or “system.” Furthermore, aspects of the disclosures herein may take the form of a program product embodied in one or more machine readable medium(s) having machine readable program code embodied thereon.

Any combination of one or more machine readable medium(s) may be utilized. The machine readable medium may be a machine readable signal medium or a machine readable storage medium. A machine readable storage medium may be, for example, a system, apparatus, or device that uses electronic, magnetic, optical, electromagnetic, infrared, or semiconductor technology, or a combination thereof. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium does not include transitory, propagating signals.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Program code for carrying out operations for aspects of the disclosures herein may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine. Examples of a machine that would execute/interpret/translate program code include a computer, a tablet, a smartphone, a wearable computer, a robot, a biological computing device, etc.

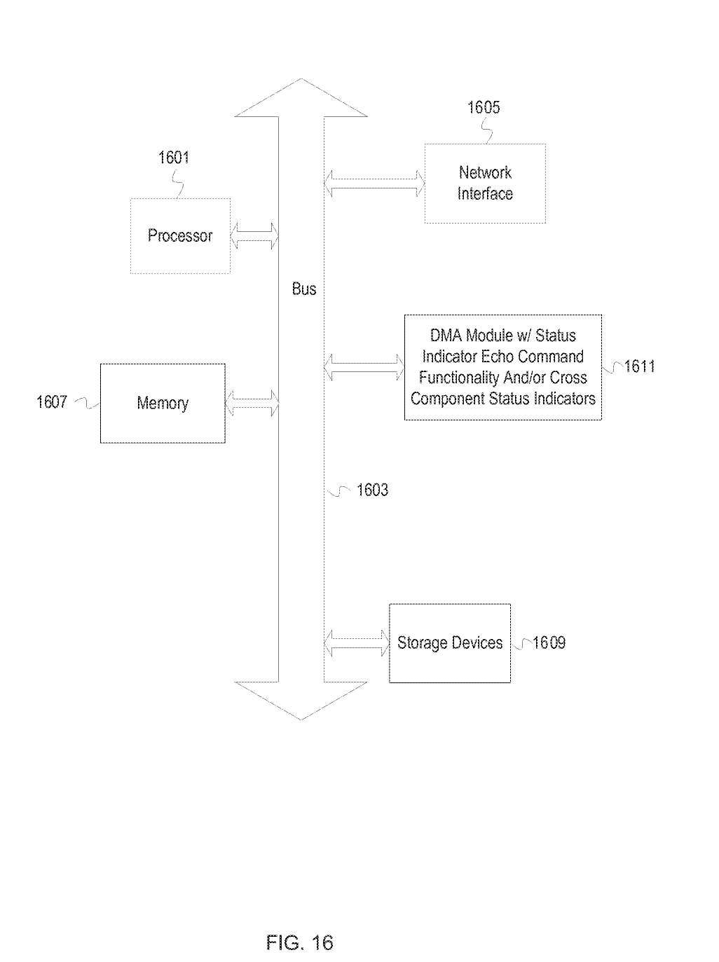

FIG. 16 depicts an example computing system with a DMA module that includes cross component status indicators and/or echo command functionality. A computing system includes a processor unit 1601 (possibly including multiple processors, multiple cores, multiple nodes, and/or implementing multi-threading, etc.). The computing system includes memory 1607. The memory 1607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 1603 (e.g., PCI, ISA, PCI-Express, HyperTransport® bus, InfiniBand® bus, NuBus, etc.), a network interface 1605 (e.g., an ATM interface, an Ethernet interface, a Frame Relay interface, SONET interface, wireless interface, etc.), a storage device(s) 1609 (e.g., optical storage, magnetic storage, etc.), and a DMA module 1611. The DMA module 1611 embodies functionality to implement features described above. The DMA module 1611 may include one or more functionalities that facilitate reading and writing status indicators to other components or computing systems. The DMA module 1611 may also include one or more functionalities that facilitate generating, issuing, and/or responding to echo commands. Any one of these functionalities may be partially (or entirely) implemented in hardware and/or on the processing unit 1601. For example, the functionality may be implemented with an application specific integrated circuit, in logic implemented in the processing unit 1601, in a co-processor on a peripheral device or card, etc. Further, realizations may include fewer or additional components not illustrated in FIG. 16 (e.g., video cards, audio cards, additional network interfaces, peripheral devices, etc.). The processor unit 1601, the storage device(s) 1609, and the network interface 1605 are coupled to the bus 1603. Although illustrated as being coupled to the bus 1603, the memory 1607 may be coupled to the processor unit 1601.

While the examples are described with reference to various aspects and exploitations, it will be understood that these examples are illustrative and that the scope of the disclosures herein is not limited to them. In general, techniques for communications between computing system components as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosures herein. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosures herein.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
determining, by a first component, to write a status indicator to a second component;
in response to said determining to write the status indicator to the second component, sending a first command to the second component, wherein the first command comprises the status indicator and an indication of a first memory location;
after sending the first command to the second component, receiving, by the first component, the status indicator from the second component; and
in response to said receiving the status indicator from the second component, writing the status indicator to memory associated with the first component, wherein the status indicator is written to a second memory location.

2. The method of claim 1 further comprising:
sending, by the first component, a second command to the second component, wherein the second command is a read command, wherein the second command indicates the first memory location;
wherein said receiving the status indicator from the second component is in response to said sending the second command to the second component.

3. The method of claim 1, wherein the first memory location identifies an echo command, wherein said receiving the status indicator from the second component is in response to said sending the first command to the second component.

4. The method of claim 3 further comprising:
receiving, by the second component, the first command;
writing, by the second component, the status indicator to the first memory location in memory associated with the second component;
determining, by the second component, that the first memory location is associated with the echo command; and
in response to said determining, by the second component, that the first memory location is associated with the echo command,
determining the second memory location;
reading, by the second component, the status indicator from the first memory location in the memory associated with the second component; and
sending, by the second component, a second command to the first component, wherein the second command is a write command, wherein the second command comprises the status indicator and the second memory location.

5. The method of claim 4, wherein said determining that the first memory location is associated with the echo command comprises:
identifying metadata based, at least in part, on the first memory location.

6. The method of claim 4, wherein said determining the second memory location comprises:
identifying metadata based, at least in part, on the first memory location; and
reading the second memory location from the metadata.

7. The method of claim 1 further comprising reading the status indicator from the second memory location after writing the status indicator to the memory associated with the first component.

8. The method of claim 1, wherein said receiving the status indicator from the second component comprises:
receiving a second command, wherein the second command is a read-response, wherein the second command comprises the status indicator and an indication of the second memory location.

9. The method of claim 1 further comprising receiving a second command, wherein the second command comprises a write command, wherein said determining to write the status indicator to the second component comprises at least one of:
detecting a flag associated with the second command;
determining that a count of issued commands is greater than a threshold; or
determining that an amount of data written to the second component is greater than a threshold.

10. A non-transitory machine readable medium having stored thereon instructions for determining the status of direct memory access write commands, the instructions comprising program code to:
detect a first echo command from a component, wherein the first echo command comprises a first status indicator and a first memory location;
in response to detection of the first echo command from the component, write the first status indicator to the first memory location;
after the first status indicator is written to the first memory location, read the first status indicator from the first memory location;
determine a second memory location, wherein the second memory location is associated with the first echo command; and
send a first write command to the component, wherein the first write command comprises the second memory location and the first status indicator.

11. The machine readable medium of claim 10,
wherein the program code to detect the first echo command from the component comprises program code to identify first metadata of a plurality of metadata based, at least in part, on the first memory location;
wherein the program code to determine the second memory location comprises program code to determine that the first metadata of the plurality of metadata identifies the second memory location.

12. The machine readable medium of claim 10, wherein the program code further comprises program code to:
receive a request to configure the first echo command, wherein the request to configure the first echo command comprises the first memory location and the second memory location;
store the first memory location and the second memory location as first metadata, wherein the first metadata identifies echo commands originating from a first process associated with the component;
receive a request to configure a second echo command, wherein the request to configure the second echo command comprises a third memory location and a fourth memory location; and
store the third memory location and the fourth memory location as second metadata, wherein the second metadata identifies echo commands originating from a second process associated with the component.

13. The machine readable medium of claim 10, wherein the program code further comprises program code to:
send, to the component, a second echo command, wherein the second echo command comprises a second status indicator and a third memory location;
receive, from the component, a second write command, wherein the second write command comprises the second status indicator and a fourth memory location; and
write the second status indicator to the fourth memory location.

14. The machine readable medium of claim 13, wherein the program code further comprises program code to:
send a request to configure the second echo command, wherein the request to configure the second echo command comprises the third memory location and the fourth memory location.

15. A device comprising:
a processor;
memory; and
a machine readable storage medium having program code stored therein that is executable by the processor to cause the device to,
determine to write a status indicator to a component;
in response to a determination to write the status indicator to the component, send a first command to the component, wherein the first command comprises the status indicator and an indication of a first memory location;
after sending the first command to the component, receive the status indicator from the component; and
in response to reception of the status indicator from the component, write the status indicator to the memory, wherein the status indicator is written to a second memory location.

16. The device of claim 15, wherein the program code further comprises program code executable by the processor to cause the device to:
send a second command to the component, wherein the second command is a read command, wherein the second command indicates the first memory location;
wherein said reception of the status indicator from the component is in response to said sending the second command to the component.

17. The device of claim 15, wherein the first memory location identifies an echo command, wherein said receiving the status indicator from the component is in response to said sending the first command to the component.

18. The device of claim 15, wherein the program code being executable by the processor to cause the device to receive the status indicator from the component comprises program code executable by the processor to cause the device to:
receive a second command, wherein the second command is a read-response, wherein the second command comprises the status indicator and an indication of the second memory location.

19. The device of claim 15, wherein the program code further comprises program code executable by the processor to cause the device to:
send, to the component, a request to configure the first command, wherein the request to configure the first command comprises the first memory location and the second memory location; and
send, to the component, a request to configure a second command, wherein the request to configure the second command comprises a third memory location and a fourth memory location.

20. The device of claim 15, wherein the program code further comprises program code executable by the processor to cause the device to receive a second command, wherein the second command comprises a write command, wherein the program code being executable by the processor to cause the device to determine to write the status indicator to the component comprises program code executable by the processor to cause the device to at least one of:
detect a flag associated with the second command;
determine that a count of issued commands is greater than a threshold; or
determine that an amount of data written to the component is greater than a threshold.
